(19) United States
(12) Patent Application Publication
(10) Pub. No.: US 2019/0301320 A1
(43) Pub. Date: Oct. 3, 2019

(54) SOUND GENERATING SYSTEM, MOTOR VEHICLE WITH A SOUND GENERATING SYSTEM, AND SOUND SENSOR UNIT FOR A SOUND GENERATING SYSTEM

(71) Applicant: Faurecia Emissions Control Technologies, Germany GmbH, Augsburg (DE)

(72) Inventors: Hannes STEINKILBERG, Augsburg (DE); Martin UNBEHAUN, Augsburg (DE)

(21) Appl. No.: 16/357,415

(22) Filed: Mar. 19, 2019

(30) Foreign Application Priority Data
Mar. 29, 2018 (DE) 10 2018 107 539.1

(51) Int. Cl. F01N 1/06; G10K 11/178

(52) U.S. Cl. CPC F01N 1/065; G10K 2210/12822; G10K 11/17825

(57) ABSTRACT

A sound generating system for an exhaust system of an internal combustion engine of a motor vehicle includes an electrically actuatable sound generating device to generate sound outside a vehicle interior space. A sound sensor is configured to detect the sound generated by the sound generating device in combination with sound carried by an exhaust gas stream outside the exhaust system. The sound sensor is arranged in a region of a license plate or a rearview camera of the motor vehicle. Furthermore, a motor vehicle includes such a sound generating system. In addition, there is presented a sound sensor unit for such a sound generating system.

### CROSS-REFERENCE TO RELATED APPLICATIONS

This application is a U.S. non-provisional application claiming the benefit of German Patent Application No. 10 2018 107 539.1, filed on Mar. 29, 2018, which is incorporated herein by its entirety.

### FIELD OF INVENTION

The invention relates to a sound generating system for an exhaust system of an internal combustion engine of a motor vehicle that includes electrically actuatable sound generating device to generate sound outside a vehicle interior space and to optionally superimpose said sound with the sound of the internal combustion engine carried by an exhaust gas stream. The system also includes a sound sensor that is configured to detect sound generated by the sound generating device in combination with sound carried by the exhaust gas stream outside the exhaust system.

The invention also relates to a motor vehicle with such a sound generating system.

Furthermore, the invention relates to a sound sensor unit for such a sound generating system.

### BACKGROUND OF THE INVENTION

Sound generating systems and motor vehicles equipped therewith are known from the prior art.

The generated sound is used to superimpose sound of the internal combustion engine carried by the exhaust gas stream such that a negative interference between the sound carried by the exhaust gas stream and the sound generated by the sound generating device is obtained. The sound carried by the exhaust gas stream thus is attenuated or eliminated. In this connection, sound generating systems also are referred to as active sound attenuation systems.

Alternatively, such sound generating systems can be used to supplement the sound carried by the exhaust gas stream with sound generated by the sound generating device such that in total a summation sound or a soundscape is obtained, which is perceived as appealing by a vehicle user. In this case of application, the sound generating system in the prior art also is referred to as a sound generator. In connection with supplementing the sound carried by the exhaust gas stream with sound generated by the sound generating device reference also is made to sound design.

Sound sensors or sound sensor units that are configured to detect a summation sound that results from a constructive and/or destructive superposition of the sound carried by the exhaust gas stream with a sound generated by the sound generating device likewise are known. For such sound sensors, the term error sensor or error microphone in part is used.

The values detected by such sound sensors can be analyzed in connection with a control or regulation of the sound generating system. The sound generating device can take account of the associated sensor values in its operation. In other words, the sound generating device can be readjusted if the detected summation sound does not correspond to the desired sound.

In known sound generating systems, sound sensors are mounted in the region of the exhaust system in order to be able to detect the aforementioned summation sound as reliably as possible.

It is the object of the invention to create sound generating systems and associated motor vehicles which are improved with regard to the sound sensor used. In particular, a high functional reliability of the sound sensor shall be achieved.

### SUMMARY OF THE INVENTION

A sound generating system includes a sound sensor that is arranged in a region of a license plate or a rearview camera of the motor vehicle. In contrast to the prior art, the sound sensor hence is arranged outside the exhaust system and in particular not mounted on exhaust-gas-conducting lines or components. It is also spaced apart from the exhaust system. In addition, the sound sensor is arranged at a comparatively large distance from a roadway on which the vehicle equipped with the sound generating system can move. This reduces the risk that the sound sensor is impaired in its function by dirt stirred up from the roadway, wetness, or other particles. In particular, this also applies for snow and ice. Preferably, the sound sensor is mounted above the license plate. Thus, the sound sensor can be operated particularly reliably.

“In the region” means a maximum distance of 100 mm from the license plate or the rearview camera. In a preferred embodiment, the license plate is arranged above a bumper of the motor vehicle. The license plate hence is attached to the motor vehicle outside the bumper. The aforementioned effects and advantages thereby are achieved to a particularly large extent.

Preferably, the sound generating device is a loudspeaker. Such sound generating devices have proved successful in the prior art and are available on the market at low cost.

The sound generating device and the sound sensor also can be components of a sound regulation circuit. In this case, the sound sensor is used as an error sensor and measures an actually present summation sound that results from a superposition of the sound carried by the exhaust gas stream and the sound generated by the sound generating device. In a regulation unit this actually present summation sound then is compared with a desired summation sound. Depending on whether there is a deviation between the same and depending on the kind of deviation, the sound generating device then can be actuated such that it eliminates or at least reduces this deviation. With such a system particularly good results can be achieved in the active sound attenuation and/or in the sound design.

The sound sensor can be arranged in a housing of the license plate illumination, wherein in the housing a license plate illumination component, e.g. a lamp, additionally is provided, or wherein the housing is a license plate holder or is directly connected to a license plate holder. Due to the arrangement in the housing, the sound sensor is protected from undesired environmental influences. Via the housing, it can also be mounted on the motor vehicle easily and reliably. Since the license plate illumination component additionally is arranged in the housing, a functional integration takes place. The consequence is that in general a very small installation space is required for the sound sensor and the license plate illumination component. Moreover, the manufacture of the integrated component is distinctly easier and less expensive as compared to a license plate illumination component and a separate sound sensor each in its own housing. The same applies when the housing is a license plate holder or is connected to a license plate holder.

Alternatively, the sound sensor can be arranged in a housing of the rearview camera, wherein in the housing a rearview camera component, e.g. a lens system of the camera, additionally is provided. In this way, there is also created an integrated component that can be manufactured easily and at low cost and only has a small space requirement.

According to one embodiment, the sound generating device is configured to introduce sound into an exhaust gas stream conducted in an exhaust system. Hence, sound generated by the sound generating device is superimposed with sound carried by the exhaust gas stream. This takes place within the exhaust system. The sound generating device hence is connected to the exhaust system in a sound-conducting way. This configuration leads to the fact that the sound carried by the exhaust gas stream spreads in a comparatively defined way and thus a targeted completion or attenuation of this sound is possible.

Preferably, the sound generating device is coupled with an acoustic horn or a sound conducting funnel and can introduce sound into the exhaust gas stream via the acoustic horn or the sound conducting funnel. Such a coupling of the sound generating device with the exhaust system is particularly effective with regard to influencing the sound carried by the exhaust gas stream. Thus, an effective sound generating system can be created.

Advantageously, the sound generating system includes a heating device to heat the sound sensor. The sound sensor thereby can be operated substantially independent of an ambient temperature. This applies in particular with regard to comparatively low ambient temperatures. Preferably, in this connection the temperature of the sound sensor can be kept above the freezing point so that snow or ice possibly adhering to the sound sensor can reliably be removed via the heating device. In addition, the formation of snow or ice on the sound sensor can of course also reliably be prevented by the heating device. Hence, the sound sensor is particularly reliable in winter operation.

In one variant, the sound generating system is configured such that it attenuates the sound emitted via the exhaust gas stream or emits an additional, audible noise. In the first case, the sound generating system hence acts as an active sound absorber. The objective is to extinguish the sound emitted by the exhaust gas stream by anti-phase sound generated by the sound generating system. In the second case it is important to supplement the sound emitted via the exhaust gas stream such that a summation sound perceived as pleasant by a user is obtained. The sound generating system then is a sound generator. The sound generating system of course can also be operated such that at certain frequencies it operates as an active sound absorber and at the same time in other frequency ranges as a sound generator.

The sound generating device can also be fluidically coupled with the exhaust system and couple the generated sound into the exhaust gas. In this way, a particularly efficient superposition of the sound carried by the exhaust gas stream with the sound generated by the sound generating device can be realized. Thus, the sound generating system operates particularly effectively.

Furthermore, the object is achieved by a motor vehicle with a sound generating system according to the invention. In such a motor vehicle the sound sensor hence operates particularly reliably. This applies in particular with regard to an impairment of the function of the sound sensor by dirt, snow and/or ice. Such a vehicle can thereby be moved particularly quietly when the sound generating system is an active sound attenuation system. For the case that the sound generating system is configured as a sound generator, a motor vehicle equipped therewith emits a particularly appealing sound. As explained already, the sound generating system can operate in various frequency ranges both as a sound generator and as a sound attenuation system.

In addition, the object is achieved by a sound sensor unit for a sound generating system for an exhaust system of an internal combustion engine of a motor vehicle, which comprises a sound sensor arranged in a housing, which is configured to detect the sound generated by the sound generating system in combination with a sound carried by the exhaust gas stream, wherein in the housing a license plate illumination component and/or a rearview camera component is/are provided in addition or wherein the housing is a license plate holder or is connected to a license plate holder. Reference is made to the effects and advantages mentioned already.

### BRIEF DESCRIPTION OF THE DRAWINGS

The invention will be explained below with reference to various exemplary embodiments that are shown in the attached drawings, in which:

FIG. 1 shows a motor vehicle of the invention with a sound generating system of the invention according to a first embodiment,

FIG. 2 shows a detail II of FIG. 1 in an enlarged representation,

FIG. 3 shows a sound generating system of the invention according to a second embodiment in a representation corresponding to FIG. 2,

FIG. 4 shows a sound generating system of the invention according to a third embodiment in a representation corresponding to FIG. 2,

FIG. 5 shows a rear view of the motor vehicle of the invention as shown in FIG. 1, wherein beside the sound generating system of the invention a sensor unit of the invention can be seen,

FIG. 6 shows the sensor unit of FIG. 5 in an enlarged representation,

FIG. 7 shows a sensor unit of the invention according to an alternative embodiment, and

FIG. 8 shows a sensor unit of the invention according to a further embodiment.

### DETAILED DESCRIPTION

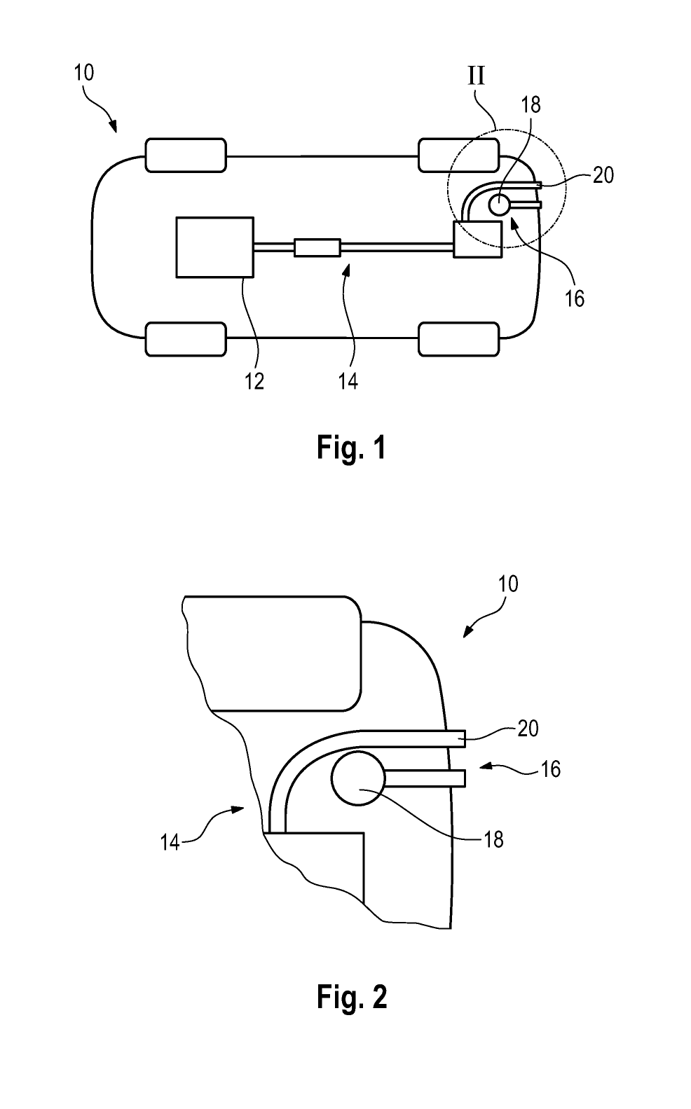

FIG. 1 shows a motor vehicle 10 with an internal combustion engine 12 and an exhaust system 14 connected to the internal combustion engine 12.

The motor vehicle 10 also includes a sound generating system 16. The same can be actuated electrically and for generating sound outside the vehicle interior space, it comprises a sound generating device 18 which in the present case is configured as a loudspeaker.

In the illustrated embodiments the sound generating system 16 is explained as an active sound absorber. This means that the sound generated by the sound generating system 16 is superimposed with the sound of the internal combustion engine 12 carried by the exhaust gas stream such that a resulting summation sound is attenuated or completely eliminated.

Hence, a negative interference takes place between the sound carried by the exhaust gas stream and the sound generated by the sound generating system 16.

Of course, the sound generating system 16 can also be utilized to supplement the sound of the internal combustion engine 12 carried by the exhaust gas stream, i.e. to emit an additional, audible noise. The sound generating system 16 then acts as a sound generator.

FIG. 2 shows a first embodiment in which the sound generating system 16 is arranged beside the exhaust system 14 and separate from the same. In this configuration, the superposition of the sound carried by the exhaust gas stream and the sound generated by the sound generating system 16 is effected only after the sound carried by the exhaust gas has reached the environment via an exhaust tailpipe 20.

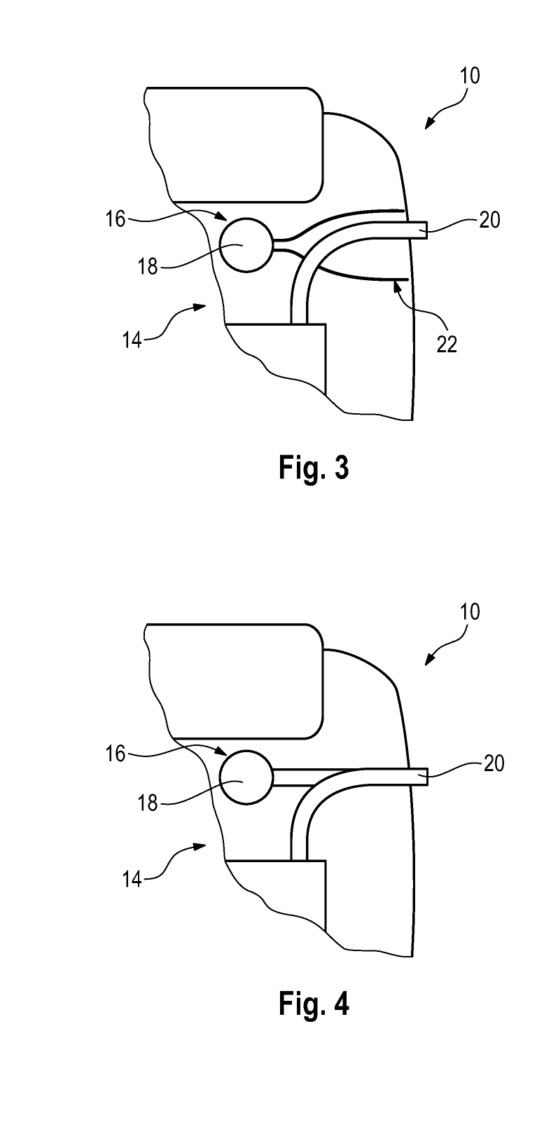

An alternative to this is shown in FIG. 3, in which the sound generating device 18 is coupled with an acoustic horn or sound conducting funnel 22 and introduces sound into the exhaust gas stream via the sound conducting funnel 22. In this configuration, too, the superposition of the sound carried by the exhaust gas stream and the sound generated by the sound generating system 16 substantially takes place in a region in which the sound carried by the exhaust gas stream has already left the exhaust tailpipe 20.

A third embodiment is shown in FIG. 4. Here, the sound generating device 18 is fluidically coupled with the exhaust system 14. The sound generated by the sound generating device 18 is coupled into the exhaust tailpipe 20. The superposition of the sound carried by the exhaust gas stream and the sound generated by the sound generating device 18 hence takes place substantially within the exhaust tailpipe 20.

The sound generating device 18 thus is configured to introduce sound into an exhaust gas stream conducted in the exhaust system 14.

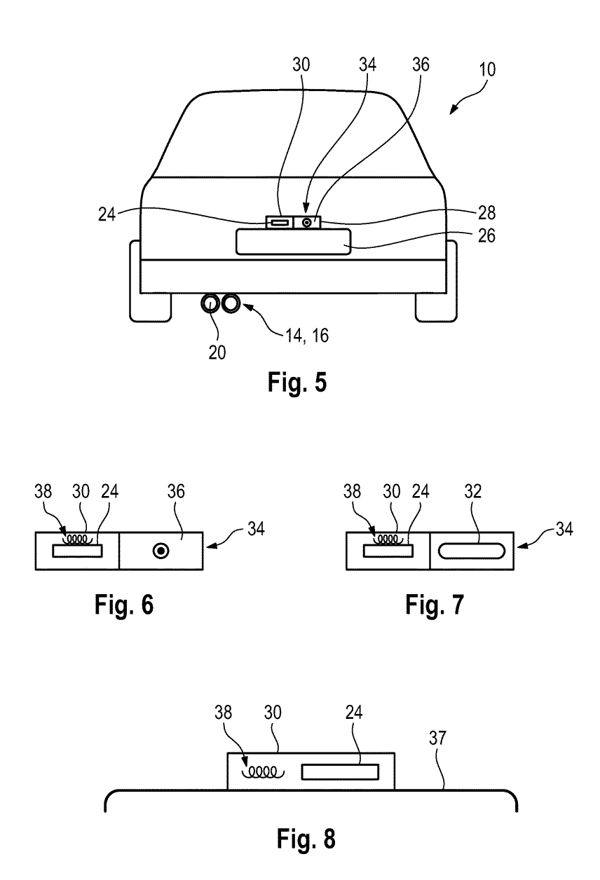

The sound generating system 16 also comprises a sound sensor 24 that is configured to detect the sound generated by the sound generating device 18 in combination with sound carried by the exhaust gas stream outside the exhaust system 14 (see in particular FIG. 5).

The sound sensor 24 is arranged in the region of a license plate 26 or a rearview camera 28.

In a motor vehicle 10 that is equipped both with a license plate 26 and with a rearview camera 8 the sound sensor 24 can of course also be arranged both in the region of the license plate 26 and in the region of the rearview camera 28. This is the case here (cf. FIG. 5).

Preferably, the sound sensor 24 is arranged in the license plate illumination or in the rearview camera 28.

According to one variant the sound sensor 24 is placed in a housing 30 of the license plate illumination, which protects the same from undesired environmental influences. According to one embodiment a license plate illumination component 32 additionally is arranged in this housing 30 (see FIG. 7), i.e. a part, e.g. the lamp, required only for the license plate illumination. Of course, electrical conductors for the illumination and/or the sound sensor 24 may protrude from the housing 30.

The housing 30 with the sound sensor 24 and the license plate illumination component 32 hence forms a sound sensor unit 34 that can be mounted on the motor vehicle 10 separate from the exhaust system 14.

The sound sensor unit 34 merely must be coupled with the sound generating system 16 for control purposes or signal transmission so that the sound generating device 18 and the sound sensor 24 can cooperate in a common control circuit.

In an alternative embodiment of the sound sensor unit 34, a rearview camera component 36 is arranged in the housing 30 (possibly in addition to the sound sensor 24), e.g. a lens and/or a light conductor. Here, the sound sensor unit 34 is integrated into the rearview camera.

In yet an alternative embodiment the sound sensor unit 34 is combined with a license plate holder 37. In FIG. 8, the same is shown as a stylized license plate holding clip.

The housing 30 can be integrally connected with the license plate holder 37. The housing 30 then can also be referred to as license plate holder 37. Alternatively, the housing 30 can releasably or unreleasably be directly connected to the license plate holder 37.

In all alternatives a heating device 38 is provided, which in FIGS. 6 to 8 is shown as a stylized filament. The sound sensor 24 can be heated by the heating device 38. Thus, its temperature in particular can be kept above the freezing point.

Although an embodiment of this invention has been disclosed, a worker of ordinary skill in this art would recognize that certain modifications would come within the scope of this disclosure. For that reason, the following claims should be studied to determine the true scope and content of this disclosure.

1. A sound generating system for an exhaust system of an internal combustion engine of a motor vehicle, comprising:
an electrically actuatable sound generating device to generate sound outside a vehicle interior space,
a sound sensor that is configured to detect the sound generated by the electrically actuatable sound generating device in combination with sound carried by an exhaust gas stream outside the exhaust system, and
wherein the sound sensor is arranged in a region of a license plate or a rearview camera of the motor vehicle.

2. The sound generating system according to claim 1, wherein the sound sensor is arranged in a housing of a license plate illumination,
wherein a license plate illumination component is provided in the housing, or
wherein the housing is a license plate holder or is directly connected to a license plate holder.

3. The sound generating system according to claim 1, wherein the sound sensor is arranged in a housing of the rearview camera, and wherein a rearview camera component is provided in the housing.

4. The sound generating system according to claim 1, wherein the electrically actuatable sound generating device is configured to introduce sound into an exhaust gas stream conducted in the exhaust system.

5. The sound generating system according to claim 4, wherein the electrically actuatable sound generating device is coupled with an acoustic horn or a sound conducting funnel and can introduce sound into the exhaust gas stream via the acoustic horn or the sound conducting funnel.

6. The sound generating system according to claim 1, wherein the sound generating system is configured such that the sound generating system attenuates the sound emitted via the exhaust gas stream or emits an additional audible noise.

7. The sound generating system according to claim 1, wherein the electrically actuatable sound generating device is fluidically coupled with the exhaust system and couples the generated sound into the exhaust gas stream.

8. The sound generating system according to claim 1, including a heating device configured to heat the sound sensor.

9. A motor vehicle comprising:
an internal combustion engine,
an exhaust system, and
a sound generating system according to any of the preceding claims.

10. A sound sensor unit for a sound generating system for an exhaust system of an internal combustion engine of a motor vehicle, comprising:
a sound sensor arranged in a housing that is configured to detect sound generated by the sound generating system in combination with sound carried by an exhaust gas stream,
wherein a license plate illumination component and/or a rearview camera component is/are provided in the housing, or
wherein the housing is a license plate holder or is directly connected to a license plate holder.

11. The sound generating system according to claim 1, wherein the electrically actuatable sound generating device superimposes said sound with a sound of the internal combustion engine carried by the exhaust gas stream.
